(19) United States
(12) Patent Application Publication
(10) Pub. No.: US 2017/0036135 A1
(43) Pub. Date: Feb. 9, 2017

(54) EDUCATIONAL CONSTRUCTION SYSTEM USING RECTANGULAR BASIC ELEMENT AND DERIVATIVES

(71) Applicant: Glen Brown, Santa Cruz, CA (US)

(72) Inventor: Glen Brown, Santa Cruz, CA (US)

(21) Appl. No.: 15/214,731

(22) Filed: Jul. 20, 2016

Related U.S. Application Data
(60) Provisional application No. 62/200,223, filed on Aug. 3, 2015.

(51) Int. Cl. A63H 33/08; G09B 1/36

(52) U.S. Cl. CPC A63H 33/084; G09B 1/36

(57) ABSTRACT

The system herein disclosed and claimed is an educational construction system.

### TECHNICAL FIELD

This invention is associated with educational systems.

### BACKGROUND OF THE INVENTION

An educational game aimed at exploring three-dimensional construction using playing-card-sized elements was first sold in the U.S. in 1952. Like playing cards, the building elements are rectangular in shape and feature six slots, four on each of the two longer sides, and two on the shorter sides.

Users make use of the building elements and their slots to interface the elements to one another and thereby create three-dimensional structures. The slots provide some rigidity and support to the structures thus assembled.

One deficiency in the original invention is that the elements are restricted by the design to interfacing cards that are oriented either horizontally or vertically, but does not allow, say, a horizontally oriented element to interface with a vertically oriented element.

As such, the scope of possible structure construction was limited.

A way to improve the original invention would be to locate the slots such that elements oriented horizontally or vertically can freely interface with one another.

### BRIEF SUMMARY OF THE INVENTION

Construction sets are known to be important educational systems for childhood brain development. Children use construction sets and their imagination to explore and learn basic concepts of mathematics and physics as well as developing aesthetic sensibility. Examples include blocks that are stacked and/or connected in various ways as well as other simple connectable elements that can be used to create increasingly complex structures according to a child's imagination. Any preschool or kindergarten classroom will include many examples of construction sets chosen for their educational value. The current invention is an educational system in this tradition.

The invention herein disclosed and claimed is a fundamental building element structure operative to allow these elements to interface with one another regardless of how a particular element is oriented. Furthermore, derivative elements are also disclosed and claimed that are derived from the fundamental building element.

As with the original invention, elements arrayed in horizontal orientations can be interfaced to one another. Elements arrayed in vertical orientations can be interfaced to one another. And, uniquely to the invention herein disclosed and claimed, elements where one or more is horizontally oriented and one or more is vertically oriented can also be interfaced.

The location of the slots provides the interface ubiquity. The positions of slots and slot dimensions are conditionally based on overall element dimensions. Thus, elements of different overall size can be implemented and retain the interface ubiquity.

### BRIEF DESCRIPTIONS OF THE DRAWINGS

FIG. 1 depicts the basic element of the original invention. As shown, it is rectangular in shape and features four slots, two on each long side; and two slots, one on each short side.

FIG. 2 is an exemplary view of the elements in FIG. 1 interfaced to one another. Note that all elements are oriented horizontally. Slot positions preclude interfacing a horizontally oriented element to a vertically oriented element in a stable configuration.

FIG. 3 is an exemplary view of the invention herein disclosed and claimed. Like the original element depicted in FIG. 1, it comprises four slots, two on each long side, and two slots, one on each short side. However, the location and dimensions of the slots allow these elements to be interfaced regardless of horizontal or vertical orientation.

FIG. 4 is an exemplary view of the basic elements of FIG. 3 interfaced such that horizontally oriented and vertically oriented elements may be interfaced.

FIG. 5 is an exemplary view of derivative elements made by using portions of the element in FIG. 3. Slot positions and sizes are all compatible with those of the element of FIG. 3.

FIG. 6 is an exemplary view of a derivative element where slots on two sides are compatible with long-side slots of the element of FIG. 3.

FIG. 7 is an exemplary view of a derivative element whose slots on one side are compatible with long-side slots of the element of FIG. 3.

### DETAILED DESCRIPTION OF THE INVENTION

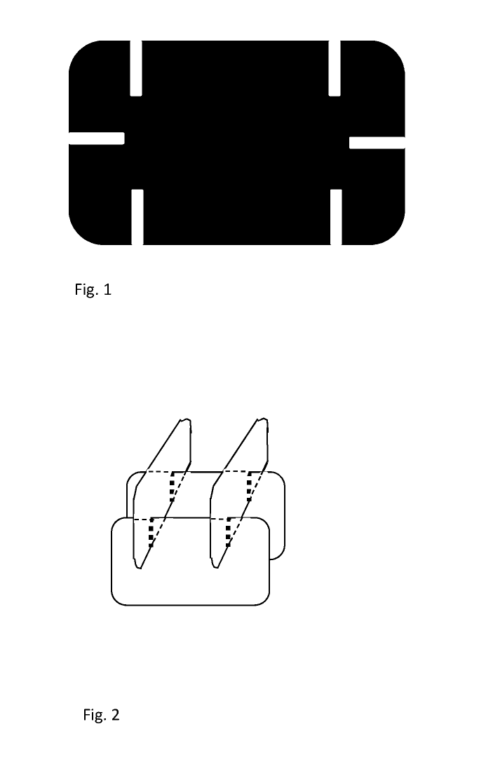

The invention herein disclosed and claimed is essentially an improvement on an earlier invention. The earlier invention uses basic construction elements that are rectangular in shape, with dimensions similar to standard playing cards, and having slots that allow two such elements to be interfaced to one another. Along the two longer sides, there are two slots per side, each perpendicular to the side as shown in FIG. 1. Along the two shorter sides, there is one slot per side, perpendicular to the side as shown in FIG. 1. The slots on the shorter side are located essentially half way between the longer sides as shown in FIG. 1. The slots on the longer side are located such that each is the equal distance from the center of a longer side, and each is equal distance from the nearest shorter side.

With a basic element such as FIG. 1, the elements are constrained to interface when all elements are oriented in the same way. That is, each element is either oriented such that the longer side is horizontal (herein referred to as horizontal orientation); or the longer side is vertical (herein referred to as vertical orientation). Interfacing an element that is horizontally oriented with one that is vertical oriented is not supported by the element shown in FIG. 1. FIG. 2 shows an example of such elements interfaced wherein each element is horizontally oriented.

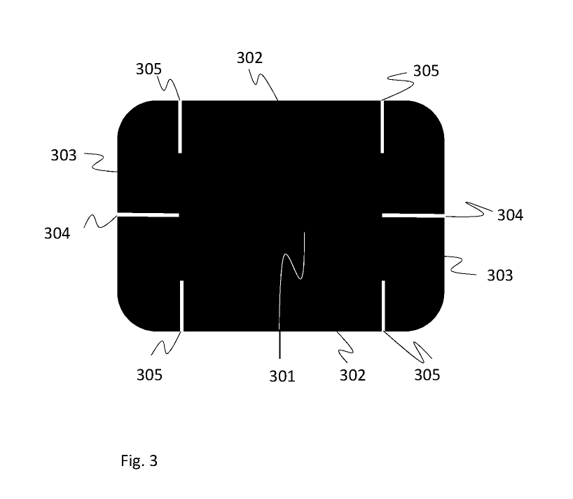

The invention herein disclosed and claimed has a construction element that is rectangular in shape and features six slots, two on each of the two longer sides and one on each of the two shorter sides, as shown in FIG. 3. Although FIGS. 1 and 3 look similar in structure, the location and dimensions of the slots in FIG. 3 are chosen such that these elements can interface with one another regardless of horizontal or vertical orientation.

Although FIG. 3 shows rounded corners, the corners can be squared. The longer sides have a length L, the shorter sides have a length W, and the element has a thickness, t. The two slots 304 are centered along each short edge (303) and are perpendicular to the edge as shown. The slots 305 along each long edge (302) are displaced a distance, c, from the slot that shares the same edge. All slots (304 and 305) have the same length, d, and width, e.

Regardless of actual element size, the relationships of c, d, and e to L, W, and t are as follows:

e≧t

c<L−2d;

d<(W−t)/4

c=2W−4d

Adherence to all four equations is a necessary condition of this invention. It is the equation c=2W-4d which is unique to this invention and provides its interface ubiquity.

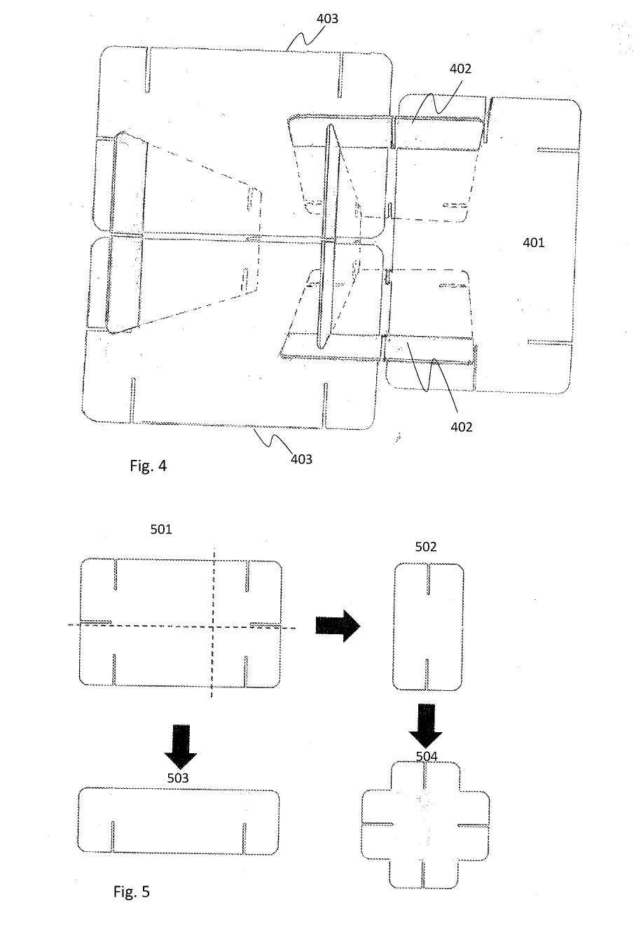

FIG. 4 is an exemplary drawing that depicts how horizontally oriented and vertically oriented elements can interface. For example, 401 is a vertically oriented element which interfaces to two horizontally oriented elements (403) via elements 402.

The educational construction system based on the rectangular element would have a number of such elements as well as derivative elements. The derivative elements are essentially portions of the rectangular element whose slot sizes and positions correspond to those of the rectangular element.

FIG. 5 is an exemplary drawing showing three derivative elements of basic rectangular element (501). By essentially dividing element 501 in half along the shorter sides, one derives element 503 whose two slots correspond to those of the two slots along the long side of element 501. By using just a portion of 501 divided along the longer sides such that one derives element 502, this derivative element is symmetrical with respect to the opposite slots, that is, the distance from the edges parallel to the two opposing slots, to the opposing slots, is equal. Two derivative elements 502 may be centered and oriented orthogonal to one another so as to form a derivative element 504. In all cases, the sizes and positions of the slots correspond to commensurate slots of element 501.

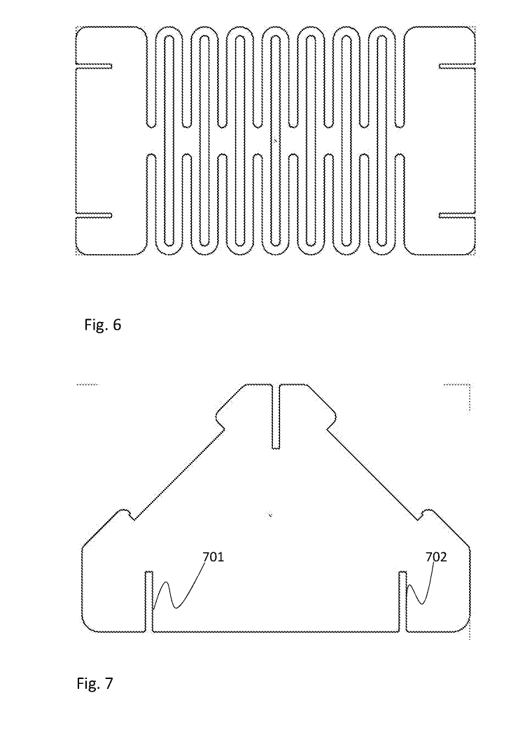

FIG. 6 is an exemplary drawing showing another derivative element where the slots shown on the left and right side correspond in size and position to those along the long side of element 501. Here, a portion of the element is fluted such that it may be bent such that the planes of the interfacing ends can be oriented up to 270 degrees apart, depending upon the material used for its construction.

FIG. 7 is an exemplary drawing showing another derivative element where the slots shown (701 and 702) are sized and positioned to correspond with the long-side slots of element 501.

The user aligns a selected slot in one element with a selected slot in another element and slides the two elements together until they are firmly engaged. By choosing various elements, orientations, and spatial arrangements, a user can create interesting and creative structures. By making the elements interface regardless of element orientation, a user has a greater number of choices in how to interface the selected elements.

The elements can be made using a variety of materials and methods. Small elements made of thin cardboard or cardstock may be cut using known die cutting methods. Larger elements made of thicker materials can be cut out using computer-controlled cutting machinery, such as a CNC router. Other manufacturing methods are also possible because the invention does not depend on a particular cutting method or material.

The derivative elements are not limited to those shown in the drawings. Any element whose slots are sized and positioned to correspond with those of the element 501 are defined as derivative and thereby covered by this disclosure and related claims. Optional variations can include additional cut-outs that do not intersect element edges, such as windows. A system could include elements of different materials and opacity as well as colors and designs.

What is claimed is:

1. A system comprising:
a planar rectangular basic element having two longer sides, two shorter sides and thickness;
each of said two longer sides has two slots containing no material and extending toward the center of said basic element perpendicularly from each of said two longer sides;
each of said two shorter sides has one slot containing no material and extending toward the center of said basic element perpendicularly from each of said two shorter sides;
each of said slots has essentially the same slot length and slot width;
said same slot width is equal to or greater than said thickness.

2. A system as in claim 1 further comprising:
said same slot length is less than one fourth of said shorter side length diminished by said thickness.

3. A system as in claim 2 further comprising:
said one slot on each of said two shorter slides is located essentially centered along said shorter side;
said two slots on each of said two longer sides is located symmetrically with the center of said longer side and each displaced from said center by essentially half of the total of two times the length of said shorter side diminished by four times said slot length.

4. A system as in claim 3 further comprising:
a derivative element of said planar rectangular element that is essentially a portion of said rectangular element whose dimensions and slot sizes and positions correspond to said planar rectangular element.

5. A system as in claim 3 further comprising:
a derivative having at least one side whose one or more slots are sized and positioned to correspond to those of said planar rectangular element.
